(19) United States
(12) Patent Application Publication
(10) Pub. No.: US 2019/0045800 A1
(43) Pub. Date: Feb. 14, 2019

(54) SLEEVE FOR MAKING PATTERNS

(71) Applicant: Sharon Knudsen, Clive, IA (US)

(72) Inventor: Sharon Knudsen, Clive, IA (US)

(21) Appl. No.: 15/672,799

(22) Filed: Aug. 9, 2017

(51) Int. Cl. A21C 3/02

(52) U.S. Cl. CPC A21C 3/021; A21C 3/028

(57) ABSTRACT

The design sleeve is the only product of its kind that features soft, pliable rolling pin covers with optional concave or convex designs that can be easily affixed on or removed from any rolling pin. The design sleeve is uniquely designed to be manufactured with food-safety silicone or silicone-like materials for optimal ease of use and durability. The sleeve has two penny-sized thumb tabs on both ends of the sleeve for ease of attachment and removal of sleeve to the rolling pin. It is intended that this product will be available with a variety of holiday, seasonal and special occasion designs to meet a variety of consumer preferences. This product is also uniquely flexible in its possible applications, in that it might be useful to artists, artisans, and others for the production of complex designs in clay, watercolor paint, or other materials.

### BACKGROUND OF THE INVENTION

### Field of the Invention

The present invention is a pattern maker. More specifically, the present invention is a pattern maker as a design sleeve on a rolling pin.

### Description of the Related Art

There are currently no feasible products on the market that offer an effective way to facilitate the quick and easy production of variable complex designs on any surface for example on baked goods. Manual carving of designs into baking dough is slow and tedious and only the most skilled of artisans can produce professional grade designs in this manner.

### SUMMARY OF THE INVENTION

The present invention is a design sleeve for making patterns that is an innovative accessory that enables even the most unskilled user to quickly produce high-quality designs on baking dough and other materials.

The design sleeve includes a tubular sleeve incorporating embossed designs.

It is an object of the present invention to provide two penny-sized thumb tabs on both ends of the design sleeve to aid in placing and removing the design sleeve on the rolling pin.

It is an object of the present invention to simply slide the sleeve over any rolling pin and use the designs on other materials such as clay, paint on cloth, paper, furniture, and walls.

It is an object of the present invention to have the built-in designs effortlessly rolled into the surface of the dough.

It is an object of the present invention to provide a soft, pliable design sleeve using the penny-sized thumb tabs.

It is an object of the present invention to provide concave or convex designs that can be easily affixed on or removed from any rolling pin.

It is an object of the present invention to provide food-safety material such as silicone or silicone-like materials for optimal ease of use and durability.

It is an object of the present invention to provide a design sleeve with a variety of holiday, seasonal and special occasion designs.

It is an object of the present invention to provide an accessory useful to artists, artisans, crafters, and others for the production of simple or complex designs in dough, clay, watercolor paint, paper, furniture, walls or other materials.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a design sleeve, in accordance with one embodiment of the present invention.

FIG. 2 illustrates a front view of a rolling pin, in accordance with one embodiment of the present invention.

FIG. 3 illustrates a front view of a design sleeve, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

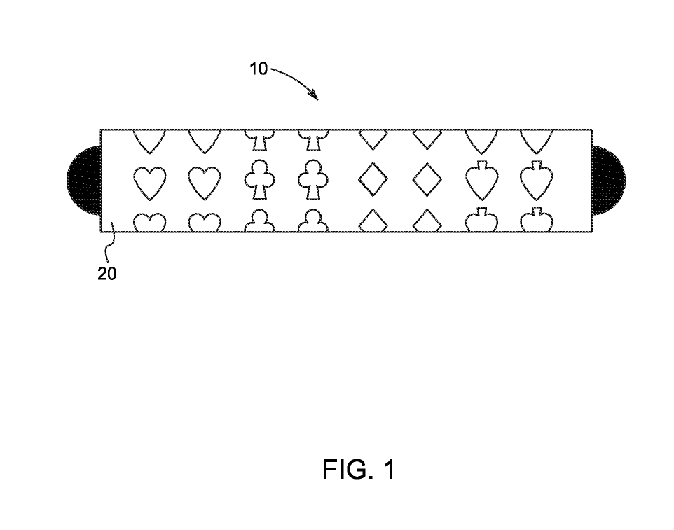

Referring now to FIG. 1, illustrated is a front view of the design sleeve 10, in accordance with one embodiment of the present invention. In FIG. 1, illustrated is a front view of the design sleeve 10, including a design 20.

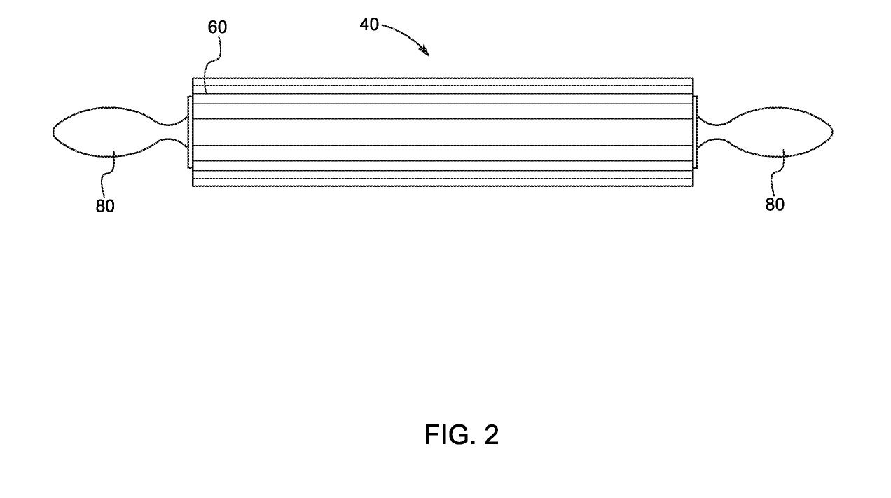

Referring now to FIG. 2, illustrated is a front view of the rolling pin 40, in accordance with one embodiment of the present invention.

In FIG. 2, illustrated is a front view of the rolling pin 40, including an elongate body 60, including handles 80 on opposite ends.

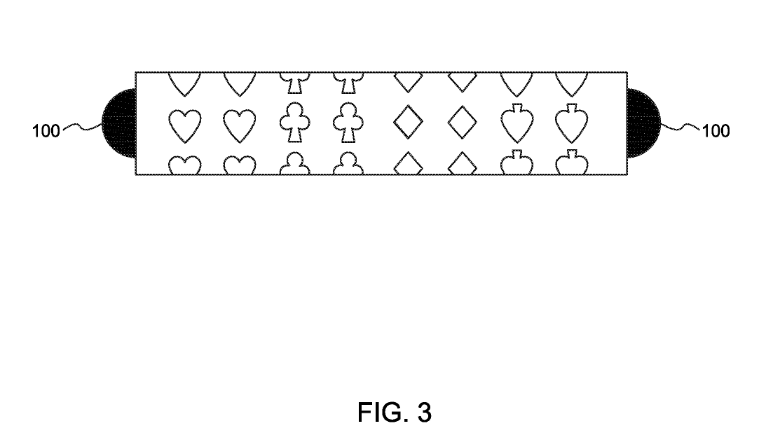

Referring now to FIG. 3, illustrated is a front view of the design sleeve 10, in accordance with one embodiment of the present invention.

In FIG. 3, illustrated is a front view of the design sleeve 10, including penny-sized thumb tabs 100 that aid in the attachment and removal of the design sleeve to the rolling pin. A design sleeve 10 the sleeve 10 has a tubular body 60 with two ends the tubular body 60 having embossed designs 20 therein; two penny-sized thumb tabs 100 on both ends of the design sleeve 10 for aiding placement and removal of the design sleeve 10 on a rolling pin 40. The sleeve according to claim 1, wherein said sleeve transfers various patterns onto baking dough. The sleeve slides over any rolling pin and the built-in designs can be effortlessly rolled into the surface of baking dough. The sleeve is a soft, pliable rolling pin cover. The designs can be concave and convex designs. The sleeve can be manufactured with food-safety, silicone or silicone-like materials for optimal ease of use and durability. The sleeve can be made with holiday, seasonal and special occasion designs. The sleeve is useful to artisans and others for the production of complex designs in clay, watercolor paint, or other materials. The sleeve transfers paint in various patterns onto a selected one of clay, paper, cloth, furniture and walls.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A design sleeve, said sleeve comprising:
a tubular body with two ends;
said tubular body having embossed designs therein;
two penny-sized thumb tabs on both ends of the design sleeve for aiding placement and removal of the design sleeve on a rolling pin.

2. The sleeve according to claim 1, wherein said sleeve transfers various patterns onto baking dough.

3. The sleeve according to claim 1, wherein said sleeve slides over any rolling pin.

4. The sleeve according to claim 1, wherein the built-in designs can be effortlessly rolled into the surface of baking dough.

5. The sleeve according to claim 1, wherein said sleeve is a soft, pliable rolling pin cover.

6. The sleeve according to claim 5, wherein said designs can be concave and convex designs.

7. The sleeve according to claim 1, wherein the sleeve can be manufactured with food-safety, silicone or silicone-like materials for optimal ease of use and durability.

8. The sleeve according to claim 1, wherein the sleeve can be made with holiday, seasonal and special occasion designs.

9. The sleeve according to claim 1, wherein the sleeve is useful to artisans and others for the production of complex designs in clay, watercolor paint, or other materials.

10. The sleeve according to claim 1, wherein said sleeve transfers paint in various patterns onto a selected one of clay, paper, cloth, furniture and walls.
